(19) United States
(12) Patent Application Publication
(10) Pub. No.: US 2026/0022827 A1
(43) Pub. Date: Jan. 22, 2026

(54) A BICYCLE LIGHT DEVICE

(71) Applicant: Bookman AB, Stockholm (SE)

(72) Inventor: Victor KABO, Sollentuna (SE)

(21) Appl. No.: 18/993,505

(22) PCT Filed: Jul. 6, 2023
(86) PCT No.: PCT/SE2023/050717

§ 371 Date: Jan. 10, 2025

(30) Foreign Application Priority Data
Jul. 12, 2022 (SE) 2250899-8

(51) Int. Cl. F21V 23/04; B62J 6/03; B62J 6/16; F21W 107/13

(52) U.S. Cl. CPC F21V 23/0414; B62J 6/03; B62J 6/16; F21W 2107/13

(57) ABSTRACT

A bicycle light device is provided. The bicycle light device comprises a light arranged at a front side of a housing of the bicycle light device. The bicycle light device further comprises a first control means configured for switching the light between a plurality of lighting modes, and a second control means configured for being rotated around a rotational axis of the second control means, thereby changing an intensity of light to be emitted by the light. The second control means is arranged at a surface of the at least one surface such that the rotational axis of the second control means is substantially perpendicular to the longitudinal axis of the light device.

### TECHNICAL FIELD

The present disclosure relates to bicycle light devices, especially bicycle front light devices configured for being attached to a handlebar of a bicycle.

### BACKGROUND

Bicycles have been provided with lights for more than a century, and the first bicycle lights were oil-fueled. However, modern bicycle lights are powered electrically. Further, modern bicycle lights often utilize electrical lighting, such as light emitting diodes, LEDs, halogen lights, high-intensity discharge, HID, lights, or xenon lights. Such electrical lighting, especially LEDs, allow the size of bicycles lights to be greatly reduced. The reduced size increases the portability of the bicycle lights, as well as making it easier to attach them to the bicycles. Therefore, a lot of modern bicycle lights are intended to be attached to the bicycle during riding, and to, consequently, be taken of the bicycle when finished riding. However, even though the size and portability of the bicycle lights have been improved, the usability of bicycle lights have remained mostly the same since their conception. The usability of bicycle lights may be of even higher importance when used for sports bicycles, such as racing bicycles or mountain bikes, which may be ridden during very rough and/or difficult conditions.

### SUMMARY

It is therefore an object of the present invention to provide a bicycle light device which provides an improved usability and/or adjustability.

According to an aspect of the present disclosure, a bicycle light device is provided. The bicycle device comprises a housing having a front side and a back side. The back side is arranged opposite the front side. The housing further comprises at least one surface extending between the front side and the back side and along a longitudinal axis of the light device. The bicycle light device further comprises a light arranged at the front side of the housing, and fastening means configured for fastening the bicycle light device to a handlebar of a bicycle such that the longitudinal axis of the bicycle light device is substantially perpendicular with a longitudinal axis of the handlebar. The bicycle light device further comprises a first control means configured for switching the light between a plurality of lighting modes, and a second control means configured for being rotated around a rotational axis of the second control means, thereby changing an intensity of light to be emitted by the light. The second control means is arranged at a surface of the at least one surface such that the rotational axis of the second control means is substantially perpendicular to the longitudinal axis of the light device.

Many modern bicycle lights comprise a switch for turning on the light. Further, the switch may be used to switch between modes of operation, such as, for example, from an off-mode, to a plurality of light intensity levels. Furthermore, the light may comprise one or more flashing modes, in which the bicycle light may flash according to predetermined patterns. Thereby, the switch may be used to switch between a large number of modes of operation, which may include five, six, or more modes of operation. Further, the switch of many modern bicycle lights is used to cycle through the modes of operation. Therefore, a user may have to cycle through all of the modes of operation before reaching an intended mode.

The present disclosure is based on the concept of using two separate control means, i.e. the first and second control means, to control the lighting of the bicycle light. By using two separate control means, the user may quickly switch between different lighting modes, without having to step through the different intensities of each mode. Thereby, an intended lighting mode and intensity setting may be reached quicker. Further, manipulating the second control means by rotating it around its rotational axis may be more ergonomic, easier and/or faster for a user than pressing a button or toggling a switch.

Specifically, the rotational axis of the second control means being substantially perpendicular to the longitudinal axis of the light device may provide further ease and speed of manipulation. Thereby, the present disclosure may provide a bicycle light device which provides an improved usability and/or adjustability.

The housing may alternatively be understood as, for example, an enclosure, a casing or an envelope. Further, the top side and the back side may, alternatively, be understood as a front and a back, respectively.

The light may be understood as a bicycle light or a lamp. Further, the light may be, or comprise, a light emitting diode, LED. The bicycle light device may further comprise a battery for powering the light. The battery may be arranged within the housing. The battery may be a rechargeable battery, which may be charged via a cable connected to the bicycle light device.

The fastening means may be configured as a strap, wherein the strap may be configured to fasten the bicycle light device by being arranged around a handlebar of a bicycle. Alternatively, the fastening means may be configured as a mount, wherein the mount may be configured to be connected to a holder arranged on the handlebar. The holder may be further configured for holding, or mounting, other peripherals, such as, for example, a bicycle computer. The mount may be in accordance with a set of standard mounts, such as, but not limited to, a GoPro-mount or a Garmin-mount.

The term longitudinal axis of the handlebar may, alternatively, be understood as a longitudinal extension of the handlebar, which may be defined as, for example, an extension or direction between two handles, or handle grips, of the handlebar. Further, the longitudinal axis of the handlebar may be parallel with a rotational axis of the front wheel of the bicycle, to which the handlebar is connected.

That the longitudinal axis of the bicycle light device is substantially perpendicular with, or to, a longitudinal axis of the handlebar may be understood as the bicycle light device being directed, or aimed, forwards (with respect to the bicycle), especially that the front side, at which the light is arranged, is directed, or aimed, forwards.

It is to be understood that the present disclosure is not limited to the rotational axis of the second control means being substantially perpendicular to the longitudinal axis of the light device. For example, an angle between the rotational axis of the second control means and the longitudinal axis of the light device may be between 45 and 90 degrees, 60 and 90 degrees, or 75 and 90 degrees.

Rotational position of the second control means may control the intensity of the light to be emitted by the light. Thus, the second control means may be configured to control the power supplied to the light. The second control means may, for example, comprise a potentiometer.

The second control means may be further configured for being rotated between a plurality of positions. The plurality of positions may, alternatively, be understood as, for example, predetermined positions and/or distinct settings. Each of the plurality of positions may be configured as a groove, such that, when the second control means is rotated, the second control means may snap into a groove of a corresponding position of the plurality of positions. The plurality of positions may be configured to provide tactile feedback to a user when being rotated to, thereby providing an indication that the second control means has been rotated into a position of the plurality of positions. Thereby, a user may operate the second control means more easily and/or more quickly, and may, for example, be able to operate second control means without having to look at the bicycle light device.

Each of the plurality of positions may relate to a different intensity of light to be emitted by the light. For example, a first position of the plurality of positions may relate a lowest intensity setting, while a last position of the plurality of positions may relate to a highest intensity setting.

The plurality of positions may comprise a first position and a last position. The second control means may be configured to only be rotatable between the first position and a subsequent position. Correspondingly, second control means may be configured to only be rotatable between the last position and a prior position. In other words, the second control means may be configured to allow rotation from the first position to the last position (potentially, via intermediate positions), and back again. Thereby, a user rotating the second control means may know that they have reached the first position, or the last position, as the second control means may not be able to be rotated further in the rotated direction, thereby providing an improved usability.

When the bicycle light device is fastened to a handlebar of a bicycle, the second control means may extend from the surface of the at least one surface in a direction which is substantially parallel with the longitudinal axis of the handlebar. Therefore, regardless if the bicycle light device is fastened on top of, or below, the handle bar, the second control means may extend in a direction which is substantially parallel with the longitudinal axis of the handlebar, albeit in opposite directions. Therefore, the user is able to see the second control means, when riding on the bicycle, regardless of whether it is arranged on top of, or below, the handlebar, thereby increasing the usability. Further, the second control means may be more easily rotated, by a user riding the bicycle, when it is extending in a direction which is substantially parallel with the longitudinal axis of the handlebar, especially when it is arranged below the handlebar.

The second control means may be configured as a rotatable knob, which may provide an improved grip, thereby making it easier for a user to adjust the light of the bicycle light device.

The plurality of lighting modes may comprise an on-mode, an off-mode, and at least one flashing mode. Manipulating the first control means may switch the light between the modes in accordance with a repeating pattern. Each flashing mode of the at least one flashing modes may entail the light being continuously turned on and off according to a respective predetermined pattern, i.e. flashing. The plurality of lighting modes may comprise a plurality of flashing modes, wherein each of the plurality of flashing modes may entail different patterns of flashing of the light. However, the plurality of modes may, alternatively, consist of an on-mode and an off-mode.

The first control means may be configured as a button or a switch. A first control means configured as a button may be configured to switch between the plurality of lighting modes by pressing of the button. Alternatively, a first control means configured as a switch may be configured to switch between the plurality modes by switching the switch between a plurality of predetermined positions of the switch.

The fastening means may be arranged at a surface of the at least one surface. The first control means may be arranged at a surface of the at least one surface.

The fastening means and the first control means may be arranged at opposite sides of the housing of the bicycle light device.

The at least one surface may comprise at least three surfaces. Further, the at least one surface may comprise at least four surfaces. A housing comprising three surfaces may have a substantially triangular cross-section along the longitudinal axis of the bicycle light device. Correspondingly, a housing comprising four surfaces may have a substantially quadratic cross-section along the longitudinal axis, and a housing comprising eight surfaces may have a substantially octagonal cross-section along the longitudinal axis.

The fastening means and the first control means may be arranged at opposite surfaces of the housing of the bicycle light device.

The first control means, the second control means and the fastening means may be arranged at different surfaces of the at least three surfaces. However, the first control means and the second control means may be arranged at a same surface of the at least three surfaces, wherein the same surface is different from a surface at which the fastening means is arranged.

The at least one surface may comprise one surface. Thereby, the housing may have a cylindrical shape. Correspondingly, a housing comprising one surface may have a substantially circular cross-section along the longitudinal axis. The fastening means, the first control means and the second control means may thereby be arranged at the same, single, surface of the housing.

It is noted that other embodiments using all possible combinations of features recited in the above-described embodiments, alternatives or examples, may be envisaged. Thus, the present disclosure also relates to all possible combinations of features mentioned herein.

### BRIEF DESCRIPTION OF DRAWINGS

Exemplifying embodiments will now be described in more detail, with reference to the following appended drawings.

FIG. 1 illustrates a bicycle light device according to an exemplifying embodiment of the present disclosure.

FIG. 2 illustrate a bicycle light device according to an exemplifying embodiment of the present disclosure fastened to a handlebar of a bicycle.

As illustrated in the figures, the sizes of elements and region may be exaggerated for illustrative purposes and, thus, are provided to illustrate the general structures of the embodiments. Like reference numerals refer to like elements throughout.

### DETAILED DESCRIPTION

Exemplifying embodiments will now be described more fully hereinafter with reference to the accompanying drawings in which currently preferred embodiments are shown. The invention may, however, be embodied in many different forms and should not be construed as limited to the embodiments set forth herein; rather, these embodiments are provided for thoroughness and completeness, and fully convey the scope of the invention to the skilled person.

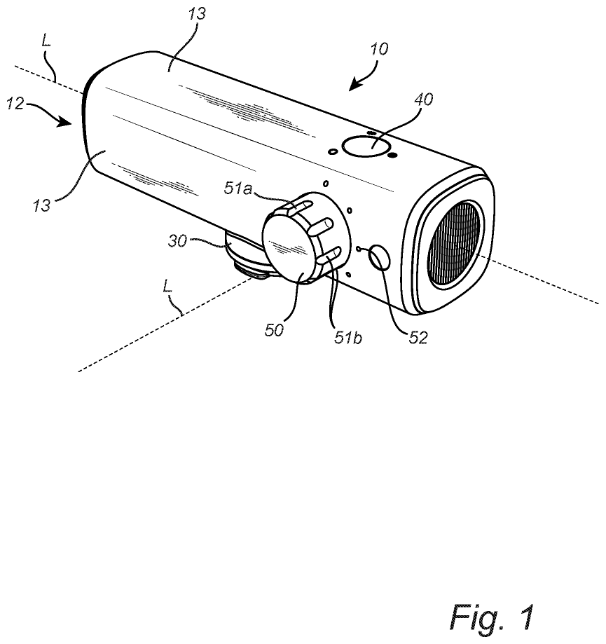

FIG. 1 illustrates a bicycle light device 1 according to an exemplifying embodiment of the present disclosure.

The bicycle light device 1 comprises a housing 10 having a front side 11 and a back side 12. The front side 11 and the back side 12 are arranged opposite each other. The housing 10 has an elongated rounded square shape. Thus, the housing 10 comprises four surfaces 13. Corners between the four surfaces 13 are rounded. The four surfaces 13 extend between the front side 11 and the back side 12 and along a longitudinal axis L of the bicycle light device 1. The surfaces 13 may also be understood as joined sides of the housing 10. Further, the housing 10 is not limited to comprising four surfaces 13, or four sides, and may comprise substantially any number of surfaces 13, or any number of sides. The corners may be sharp, or may be rounded to different degrees.

The housing 10 may, for example, have a length, along the longitudinal axis L, of between 60 and 180 mm, or between 90 and 150 mm, or 120 mm+−15%. A height and/or width of the housing 10, i.e. a height and/or width of the front side 11 and the back side 11, may, for example, be between 20 and 40 mm, or between 25 and 35 mm.

The front side 11 of the housing 10 houses a light 20. The light 20 is configured to be switched between a plurality of lighting modes, such as on-mode and off-mode, and possibly one or more flashing mode(s).

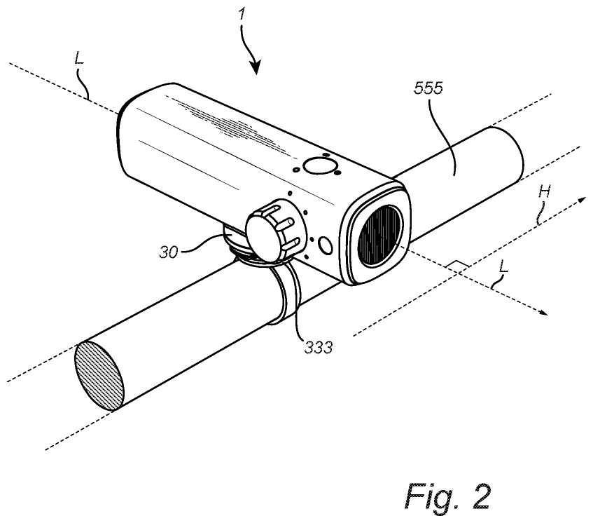

The bicycle light device 1 further comprises fastening means 30 configured for fastening the bicycle light device 1 to a handlebar (not shown; see FIG. 2) of a bicycle (not shown) such that the longitudinal axis L of the bicycle light device 1 is substantially perpendicular with a longitudinal axis H of the handlebar. The fastening means 30 shown in FIG. 1 is configured as a mount configured to be fastened to a holder attached to the handlebar. It is to be understood that the fastening means 30 is not limited to being configured as a mount, and may be configured as, for example, a strap. The fastening means 30 is arranged on a surface (not shown) of the housing 10 which is shown in FIG. 1 as being a lowermost surface.

The bicycle light device 1 comprises a first control means 40 configured for switching the light 20 between the plurality of lighting modes. The first control means 40 shown in FIG. 1 is configured as, but not limited to, a button 40. The button 40 is arranged at a uppermost surface 13 of the housing 10 as shown in the view of FIG. 1. Thus, the button 40 and the fastening means 30 shown in FIG. 1 are arranged on opposite surfaces 13 of each other 10.

The bicycle light device 1 further comprises a second control means 50. The second control means 50 is configured for being rotated around a rotational axis R of the second control means 50. By rotating the second control means 50 an intensity of light to be emitted by the light 20 is changed. The second control means 50 is arranged at a surface 13 of the housing 10. The surface 13 at which the second control means 50 is arranged is arranged between the uppermost and the lowermost surfaces 13. The rotational axis R of the second control means 50 is substantially perpendicular to the longitudinal axis L of the bicycle light device 1.

The second control means 50 is configured as rotatable knob. The second control means 50 comprises a plurality of grooves 51a, 51b, wherein one of the grooves 51a may be a marked groove 51a. The marked groove 51a may provide an indication of the rotational position of the second control means 51a. Further, the surface 13 of the housing 10 at which the second control means 50 is arranged comprises indicating means 52 for indicating a plurality of positions for the second control means 50 to be rotated to. The indicating means 50 are shown in FIG. 1 as marking circles on the surface 13. Thereby, it is provided a intuitive and easily viewable indication of a current setting of the second control means 50. Thus, the bicycle light device 1 provides an improved usability.

The bicycle light device 1 may comprise a battery (not shown). The battery may be arranged within the housing 10. The bicycle light device 1 may further comprise electrical wiring (not shown) interconnecting the light 20, first control means 40, the second control means 50, and/or the battery.

The battery may be a rechargeable battery. The bicycle light device 1 may comprise a charging port (not shown) for charging the rechargeable battery. The charging port may, for example, be, but is not limited to, a micro-USB-port or a USB-C-port. The charging port may be covered by a sealing lid configured for protecting the charging port from fluids when the sealing lid is closed, i.e. when the charging port is not in use. The charging port may be arranged at any of the surfaces 13 of the housing 10. For example, the charging port may be arranged on the surface 13 opposite the second control means 50.

The bicycle light device 1 may comprise a latch (not shown) arranged at the back side 12 of the housing 10. The latch may be threaded and may be configured to be screwed into the back side 12 of the housing 10, which may comprise a complimentary threading. Opening the latch may allow access into the housing 10, which may house a battery and/or electrical wiring.

FIG. 2 illustrate a bicycle light device 1 according to an exemplifying embodiment of the present disclosure fastened to a handlebar 555 of a bicycle (not shown). It should be noted that FIG. 2 comprises features, elements and/or functions as shown in FIG. 1 and described in the associated text. Hence, it is also referred to FIG. 1 and the description relating thereto for an increased understanding.

The bicycle light device 1 shown in FIG. 2 is fastened to a handlebar 555 of a bicycle (not shown). The bicycle light device 1 is fastened to the handlebar 555 via the fastening means 30 of the bicycle light device 1. The fastening means 30 shown in may be understood as being configured as a mount. The fastening means 30 is mounted on a holder 333 which is attached to the handlebar via straps. Thereby, the bicycle light device 1 may easily and quickly be mounted and unmounted onto or off the handlebar 555. However, the fastening means 30 may be configured in differently. For example, the fastening means 30 may comprise a strap configured to be strapped around the handlebar 555, or may comprise a magnet for magnetically fastening the bicycle light device 1 to the handlebar 555.

FIG. 2 illustrates the longitudinal axis L of the bicycle light device 1. Further, FIG. 2 illustrates a longitudinal axis H of the handlebar 555, which is displaced from the handlebar 555 to provide an increased understanding of the present disclosure. The longitudinal axis H of the handlebar 555 is parallel with a longitudinal extension of the handlebar 555. The longitudinal axes L, H are substantially perpendicular to each other. Thus, the bicycle light device 1 is facing a direction which the bicycle is heading.

The invention has mainly been described above with reference to a few embodiments. However, as is readily appreciated by a person skilled in the art, other embodiments than the ones disclosed above are equally possible within the scope of the invention, as defined by the appended patent claims. Further, although features and elements are described above in particular combinations, each features or element can be used alone without the other features and elements or in various combinations with or without other features and elements.

Additionally, variations to the disclosed embodiments can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain features are recited in mutually different dependent claims does not indicate that a combination of these features cannot be used to advantage.

1. A bicycle light device comprising:
a housing having
a front side and a back side, wherein the back side is arranged opposite the front side, and
at least one surface extending between the front side and the back side and along a longitudinal axis of the bicycle light device;
a light arranged at the front side of the housing;
fastening means configured for fastening the bicycle light device to a handlebar of a bicycle such that the longitudinal axis of the bicycle light device is substantially perpendicular with a longitudinal axis of the handlebar;
a first control means configured for switching the light between a plurality of lighting modes; and
a second control means configured for being rotated around a rotational axis of the second control means, thereby changing an intensity of light to be emitted by the light, and wherein the second control means is arranged at a surface of the at least one surface such that the rotational axis of the second control means is substantially perpendicular to the longitudinal axis of the light device.

2. The bicycle light device according to claim 1, wherein the second control means is further configured for being rotated between a plurality of positions, wherein each of the plurality of positions relates to a different intensity of light to be emitted by the light.

3. The bicycle light device according to claim 1, wherein, when the bicycle light device is fastened to the handlebar, the second control means extends from said surface of the at least one surface in a direction substantially parallel with the longitudinal axis of the handlebar.

4. The bicycle light device according to claim 1, wherein the second control means is configured as a rotatable knob.

5. The bicycle light device according to claim 1, wherein the plurality of lighting modes comprises an off-mode, at least one on-mode, and at least one flashing mode.

6. The bicycle light device according to claim 1, wherein the first control means is configured as a button or a switch.

7. The bicycle light device according to claim 1, wherein the fastening means is arranged at a surface of the at least one surface.

8. The bicycle light device according to claim 1, wherein the first control means is arranged at a surface of the at least one surface.

9. The bicycle light device according to claims 7, wherein the fastening means and a first control means are arranged at opposite sides of the housing of the bicycle light device.

10. The bicycle light device according to claim 1, wherein the at least one surface comprises at least three surfaces.

11. The bicycle light device according to claim 10, wherein the first control means, the second control means and the fastening means are arranged at different surfaces of the at least three surfaces.

12. The bicycle light device according to claim 1, wherein the at least one surface comprises one surface.
